(19) United States
(12) Patent Application Publication
(10) Pub. No.: US 2022/0177361 A1
(43) Pub. Date: Jun. 9, 2022

(54) GLASS ETCHING PREPARATION METHOD AND SYSTEM

(71) Applicant: Pierce Protocols Limited, London (GB)

(72) Inventors: Jörg Lotz, Dusseldorf (DE); Dirk-Hinnerk Meyer, Köln (DE)

(21) Appl. No.: 17/599,350

(22) PCT Filed: Mar. 27, 2020
(86) PCT No.: PCT/EP2020/058817

§ 371 Date: Sep. 28, 2021

(30) Foreign Application Priority Data
Mar. 29, 2019 (GB) 1904473.4
Apr. 2, 2019 (DE) 202019101902.6
May 24, 2019 (DE) 102019113960.0
May 24, 2019 (GB) 1907355.0

(51) Int. Cl. C03C 15/00; B41J 3/407; B41M 3/00; B41M 5/00

(52) U.S. Cl. CPC C03C 15/00; B41J 3/4073; B41M 5/007; B41M 5/0047; B41M 3/006

(57) ABSTRACT

A method of preparing glass for etching includes providing a section of the glass and printing a mask directly on to the section of the glass by depositing ink with a printer. A printing system for preparing a section of the glass for etching includes a printer configured to print a mask directly on to the section of the glass by depositing ink on to the section of the glass. A glass etching system includes a printing system for preparing a section of the glass for etching and an etching bath for receiving the section of the glass and for exposing at least a portion of the section of the glass to an etching solution in order to remove colouring from the section of the glass in areas not covered by the mask.

### TECHNICAL FIELD

The present invention relates to a method for preparing glass for etching, and a system therefor. More particularly the present invention relates to preparing hand-blown stained glass for etching.

### BACKGROUND

Etching is used to create artistic works for installations, such as architectural installations as well as other independent works of art and decorated, technical glass products. For example etching may be used to provide additional treatment features to stained glass such as stained glass windows and other glass products.

Etching is a process that utilises a strong acid in order to remove parts of a material surface so as to produce a design on the material surface. It is known to use etching for producing designs on stained or coloured glass. In the known process, a “mask” or “resist” is laid upon the glass. Once the mask has been laid, the glass is placed in to an etching solution. Typically the etching solution comprises an acid, such as hydrofluoric acid. The use of such acids presents a variety of safety and environmental issues. The mask is made of a material that is resistant to the acid, so that the colouring of the stained glass is removed in all areas of the glass except where the mask is present, when the glass is submerged in the etching solution. In some examples a wax, such as beeswax, is used as a mask. Alternative materials for the mask include tar paint, asphalt, plastic vinyl, latex, or other plastic-based glues. Once the glass is removed from the etching solution, the mask can be removed from the glass to reveal the etched surface comprising the desired design.

In the known process, the laying of the mask is slow and laborious which limits the number of pieces that can be produced. The mask is also typically hand-laid, so is often laid in an imperfect fashion. Hand applied masks are unstable and prone to lifting from the surface of the glass.

Masks have to be designed manually and hand-made before they are laid down as well, which also increases time taken.

A characteristic of stained glass is that it is not flat. Glass can be made that is perfectly flat, for example using the float glass process, but authentic stained glass is not made this way. It is hand blown, which creates imperfection and variations in thickness, which though aesthetically desirable present difficulties in etching. Currently, etching on stained glass is time-consuming and achieving a high quality finish is difficult.

### SUMMARY OF INVENTION

According to a first aspect there is provided a method of preparing glass for etching, comprising: providing a section of glass; and printing a mask directly on to the section of glass by depositing ink with a printer.

According to an example the section of glass comprises stained-glass.

According to an example the section of glass is hand-blown.

According to an example the section of glass comprises flash glass having a primary layer and one or more secondary layers.

According to an example the printer comprises an ink-jet printer.

According to an example the printer comprises a 2-axis printer.

According to an example the printer comprises a 3-axis printer.

According to an example a print-head of the printer is configured to move in a depth direction of the section of glass, in order to account for variations in thickness of the section of glass.

According to an example, the method comprises depositing different thicknesses of ink at different positions on the section of glass.

According to an example, once the mask has been printed on to the section of glass, the method comprises exposing the section of glass to an etching solution in order to remove colouring from the section of glass in areas not covered by the mask.

According to an example the method comprises performing multiple exposures of the section of glass in the etching solution.

According to an example the method comprises exposing different areas of the section of glass to the etching solution a different number of times, in order to vary darkness of colouring over the section of glass. Each of the different areas may have a different mask. In some examples, each different mask is printed in a separate printing process.

According to an example the method comprises exposing different areas of the section of glass to the etching solution for different time periods, in order to vary darkness of colouring over the section of glass.

According to an example, the method comprises exposing different areas of the section of glass to a different volume per minute of the etching solution, in order to vary darkness of colouring over the section of glass.

According to an example the method comprises washing the section of glass workpiece and removing the mask in order to provide a finished glass product.

According to a second aspect there is provided a printing system for preparing a section of glass for etching, comprising: a printer configured to print a mask directly on to a section of glass by depositing ink on to the section of glass.

According to an example the section of glass comprises stained-glass.

According to an example the section of glass is hand-blown.

According to an example the section of glass comprises flash glass having a primary layer and one or more secondary layers.

According to an example the printer comprises an ink-jet printer.

According to an example the printer comprises a 3-axis printer.

According to an example the printer comprises a 2-axis printer.

According to an example a print-head of the printer is configured to move in a depth direction of the section of glass, in order to account for variations in thickness of the section of glass.

According to an example the printing system comprises a print bed for receiving a section of glass for printing.

According to a third aspect there is provided a glass etching system comprising: a printing system according to the second aspect; and an etching bath for receiving a section of glass, for exposing at least a portion of the section of glass to an etching solution in order to remove colouring from the section of glass in areas not covered by the mask.

According to an example, the glass etching system comprises a washing station for washing the section of glass so as to remove the mask in order to provide a finished glass product.

According to a fourth aspect there is provided a method of preparing glass for etching, comprising: providing a section of hand-blown stained glass; and printing a mask directly on to the section of hand-blown stained glass by depositing ink with a printer.

According to a fifth aspect there is provided a printing system for preparing a section of hand-blown stained glass for etching, comprising: a printer configured to print a mask directly on to the section of hand-blown stained glass by depositing ink on to the section of hand-blown stained glass.

### BRIEF DESCRIPTION OF FIGURES

The invention can be more fully understood by reference to the accompanying Figures, in which:

FIG. 1 shows a finished example of a decorative stained glass product, produced using the invention described in more detail below;

FIG. 2 schematically shows apparatus for producing an etching mask according to the invention;

FIGS. 3 to 5 schematically show stages of producing an etched glass article according to the invention;

FIG. 6 schematically shows a system for printing an etching mask according to the invention;

FIG. 7 shows an example of a section of glass upon which the invention may be carried-out.

### DETAILED DESCRIPTION

According to the invention, a computer numerically controlled (CNC) printer is used to form a mask on to a section of stained glass to be etched. In some examples the section of stained glass may be referred to as a glass workpiece. In some examples the printer is an inkjet printer, with the ink acting as the mask. Some examples of printers that can be used include high-end ink jet printers such as the Mimaki® JFX200, TECJET6090 Flatbed printer, and Canon® Océ 1280XT. In some examples, the ink used is a carbon based ink. An example of an ink that can be used includes the Fuji® Sericol® ink. In some examples the ink used is a white ink. White ink is cost-effective and comprises a resistant titanium oxide molecule. It will however be understood that in other examples different coloured inks may be used.

In some examples, the stained glass workpiece is hand-blown (rather than, for example, produced by the float glass process). Any hand blown glass will have surface imperfections such as having an uneven or contoured surface.

More information on hand-blown stained glass can be found for example at https://en.wikipedia.org/wiki/Broad_sheet_glass and https://www.oxfordreference.com/view/10.1093/oi/authority.20110803100214564

In some examples a 3-axis printer is used to lay the mask. The 3-axis printer has a print head that moves in the x-y plane to print the mask design or pattern onto the glass. In addition, the print head is movable in the z direction to adjust for glass thickness. In some examples the print-head does not print while moving in the z direction, and starts or resumes printing once the correct position relative to the section of glass is achieved. That is, in some examples, the height of the print head may be changed before printing, but the height will not change during the printing process.

In some examples, a 2-axis printer is used to lay the mask.

In practice, the shape of mask can be designed on a computer user interface using known computer design tools. In some examples a computer design tool which can provide a file that is suitable for a Raster Imaging Processor (RIP) is used. The designed mask can then be transmitted to the printer, which can print the mask on to the glass. This enables far more intricate masks (resolution of design etched into glass) to be formed on the glass than would ordinarily be possible by hand. It also significantly speeds up the process of preparing and laying a mask, compared to known manual techniques. The stored data set for the mask can of course also be re-used, meaning that the mask can also be easily reproduced on different or further sections of glass. In examples, use and repeated use of a same data set for a mask (e.g. designer designs mask on computer, mask data formatted by computer and sent to drive printer) also provides certainty of outcome and facilitates reproducibility and quality control of a finished product.

The present invention may reduce labour time in producing an etched glass product from hours (or even days or weeks for high detail masks) to minutes. Although the time taken is dependent on size and intricacy, by way of example to produce an intricate etched glass section that is 0.5 m² would take approximately 8 hours or so using the known, manual methods. Using the present invention this could be reduced to 4 or 5 minutes. Multiple tiles or sections could be printed to make up one larger design. For example a mask design may be printed in two or more sections on a section of glass. The glass may be moved relative to the printhead in order to allow the separate mask sections to be formed. In some examples the movement of the workpiece is performed manually by an operator between printing stages.

In addition to the time savings, the present invention enables a level of detail in the mask (and consequently the finished etched product) which previously wasn't possible. By using a CNC machine to create the mask, this enables the use of a digital set of information and volume manufacture of identical pieces. This can replace the previous, slow and expensive process, where the production time is heavily dependent on the design. For a complex design, using the old process it could take hours to cut the mask and even longer to mount the mask, with a high possibility of mistakes during the cutting.

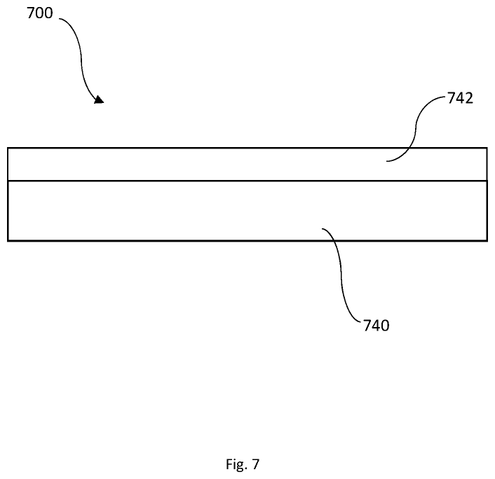

A side view of an example of a section of glass 700 that may be used in some examples is shown in FIG. 7. The glass 700 comprises a primary surface 740. The primary surface 740 may be clear. The glass 700 comprises a secondary surface 742. The secondary surface 742 comprises a coloured or stained layer. In some examples there is more than one secondary layer. That is it may be considered that there is one or more secondary layers. The glass 700 is created by placing a melted or molten section of the secondary layer 742 in to a melted or molten section of the primary layer 740 and then blowing the glass. This type of glass 700 is referred to as “flashed glass” or “flash glass”. The secondary layer 742 is the layer removed by the acid. The secondary layer 742 may also be referred to as the “flash layer”.

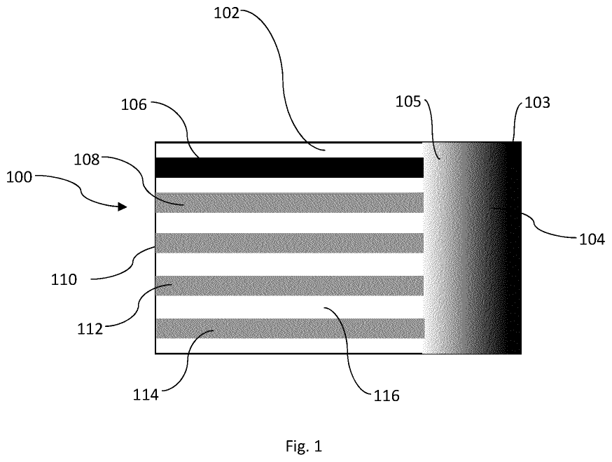

A plan view of an example of a stained glass product or article 100 formed by the disclosed method is shown in FIG. 1. The stained glass product 100 is formed on a section of glass, or glass workpiece, 102.

In this example, the areas that are shaded (i.e. areas 104, 106, 108, 110, 112, 114) correspond to areas that were covered by the printed mask, prior to placement of the glass 102 in the etching bath comprising the etching solution (acid). Areas free from shading (e.g. area 116) correspond to areas where staining has been removed during the etching process.

It will be noted that there are varying shades (e.g. darkness) of staining across the product 100. For example, within area 104, area 103 is darker than area 105. Likewise band 106 is darker than band 108. In some examples the variation of darkness is caused by varying the etching time (i.e. the amount of time the glass is subjected to the acid). The longer an area is held in the solution, the lighter that area will be. Additionally or alternatively the variation in darkness may be caused by repeating a “dip” in the acid multiple times, and possibly a different number of dips on different areas of the glass. In some examples, the process comprises exposing different areas of the section of glass to a different volume per minute of the etching solution, in order to vary darkness of colouring over the section of glass.

Additionally or alternatively the variation in darkness may be caused by varying the thickness of the printed mask across the glass. In some examples, each of the different areas may have a different mask. In some examples, each different mask is printed in a separate printing process.

Once the glass is removed from the etching solution, the glass is washed to remove any remaining acid. In some examples an isopropanol glass cleaner can be used for cleaning the glass. Then, the mask is removed so as to reveal the finished glass product (e.g. stained glass product 100).

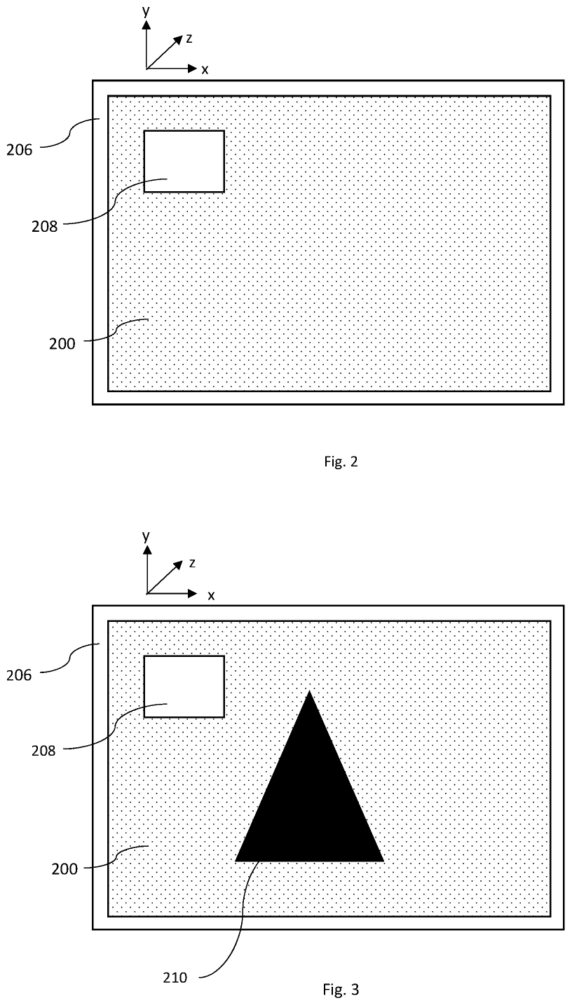

FIG. 2 is a schematic plan view of a system incorporating the invention. Glass (e.g. a section of stained glass) to be printed on is schematically shown at 200. The glass 200 may be a section of flash glass as previously described. The colour or staining of the glass 200 is schematically represented by the array of dots. The glass 200 is rested on a bed 206 of a 3-axis CNC inkjet printer. A print-head of the inkjet printer is schematically shown at 208. As discussed above, the print-head 208 can move in the x, y and z directions (the z direction being in and out of the document when viewing FIG. 2). That is the print head 208 can move across a length, breadth and depth of the glass 200. The glass 200 may be sized to match the size of the printer bed 206. Alternatively if the glass 200 is too large for the printer bed 206, then appropriate supports may be used in order to support the glass, and the glass is then moved around the printer bed in a series of printing operations, until the necessary printing is completed.

As discussed above, the CNC printer can be programmed such that the printhead 208 prints a design which has been prepared using an appropriate computer design tool.

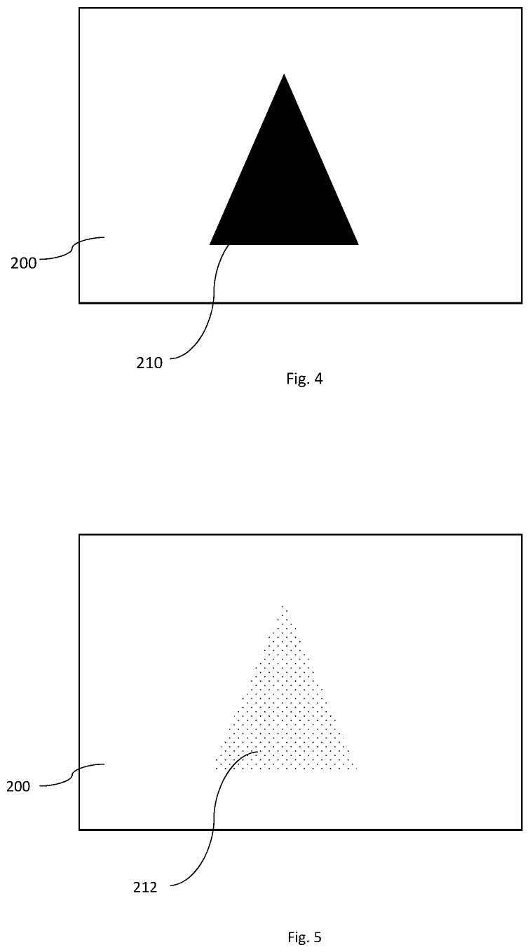

FIG. 3 shows an example where computer instructions have been sent to the printhead 208 to print a triangle 210 on to the glass 200, by moving the printhead 208 over the glass while depositing ink. The deposited ink is schematically shown by the black triangle, though it will be understood that in practice the ink may be a different colour (e.g. white).

Once the printing of the mask has completed, the glass 200 can be dipped in an etching solution (e.g. in an etching bath) as previously described, so as to cause removal of colour (staining) on the glass 200 in areas not covered by the printed mask (in this case triangular mask 210). In examples the glass 200 is placed in the etching solution by hand under very controlled conditions due to the danger to health presented by the acid. For example the person placing the glass in the etching solution will wear protective clothing such as a space suit. The method is also carried out in a remote location (e.g. away from a town or city centre), within an appropriately constructed facility having suitable air intakes and outlets and suitable cleaning equipment.

FIG. 4 schematically shows the glass 200 after being dipped in, and removed from, the etching solution. As shown schematically by the absence of dots (cf with FIG. 3), the colour has been removed from the glass 200 in the areas not covered by the mask 210. In this example all colour has been removed in these areas so that these areas are now clear (or perceptibly clear) glass, although as described above the extent of colour removal may be dependent on etching time, number of dips, thickness of the mask etc. In FIG. 4, the mask 210 has not yet been removed.

FIG. 5 schematically shows the glass 200 after the mask 210 has been removed, to reveal a corresponding triangular portion 212 where the colour of the stained glass has been retained.

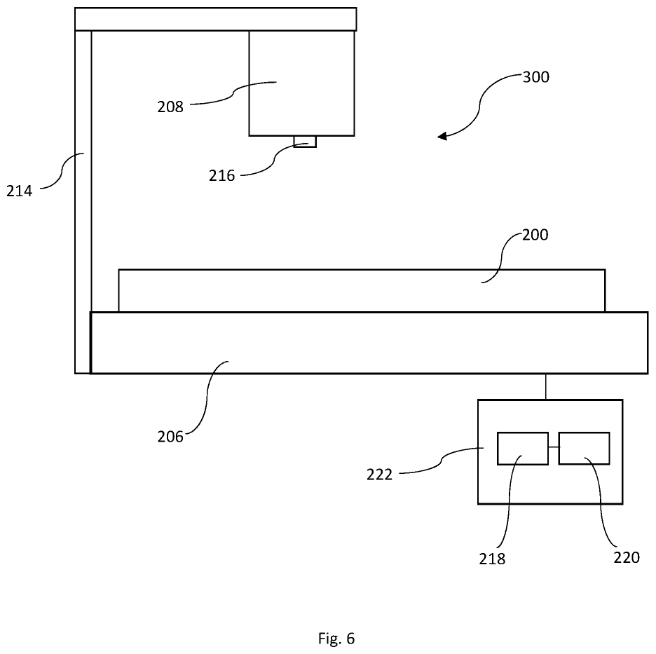

FIG. 6 schematically shows a printer 300 which may be used to carry out the described printing process. In this example the printer 300 comprises an ink-jet printer, as previously described. The printer 300 comprises bed 206 for supporting glass 200. Movement of printhead 208 over workpiece 200 in the x, y, z directions can be effected via robot arm 214 which controls movement of printhead 208. The printhead 208 comprises one or more nozzles 216 for ejecting ink on to the glass 200.

Computing apparatus is schematically shown at 222. The computing apparatus is schematically shown as having a memory 218 and a processor 220. The memory 218 may store the printer drivers necessary to control the printer 300. The memory 218 may also store data pertaining to one or more patterns to be printed on to glass 200. Functionality of the computing apparatus 222 may be in the printer 300, in an external computer in communication with the printer 300, or distributed between the printer 300 and an external computer. The printing system of FIG. 6 is configured to carry out the printing process of laying a mask as described with respect to FIGS. 2 to 5.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of preparing glass for etching, the method comprising:
providing a section of the glass; and
printing a mask directly on to the section of the glass by depositing ink with a printer.

2. The method according to claim 1, wherein the section of the glass comprises stained-glass.

3. The method according to claim 1, wherein the section of the glass is hand-blown.

4. The method according to claim 1, wherein the section of the glass comprises flash glass having a primary layer and one or more secondary layers.

5. The method according to claim 1, to wherein the printer comprises an ink-jet printer.

6. The method according to claim 1, wherein the printer comprises a 3-axis printer.

7. The method according to claim 1, a print-head of the printer being configured to move in a depth direction of the section of the glass, in order to account for variations in thickness of the section of the glass.

8. The method according to claim 1, comprising depositing different thicknesses of ink at different positions on the section of the glass.

9. The method according to claim 1, wherein once the mask has been printed on to the section of the glass, the method comprises exposing the section of the glass to an etching solution in order to remove colouring from the section of the glass in areas not covered by the mask.

10. The method according to claim 9, comprising performing multiple exposures of the section of the glass in the etching solution.

11. The method according to claim 10, comprising exposing different areas of the section of the glass to the etching solution a different number of times, in order to vary darkness of colouring over the section of the glass.

12. The method according to claim 9, comprising exposing different areas of the section of the glass to the etching solution for different time periods, in order to vary darkness of colouring over the section of the glass.

13. The method according to claim 9, comprising washing the section of the glass and removing the mask in order to provide a finished glass product.

14. A printing system for preparing a section of glass for etching, the printing system comprising:
a printer configured to print a mask directly on to the section of glass by depositing ink on to the section of glass.

15. The printing system according to claim 14, wherein the section of glass comprises stained-glass.

16. The printing system according to claim 14, wherein the section of glass is hand-blown.

17. The printing system according to claim 14, wherein the section of glass comprises flash glass having a primary layer and one or more secondary layers.

18. (canceled)

19. The printing system according to claim 14, wherein the printer comprises a 3-axis ink-jet printer; and a print-head of the printer is configured to move in a depth direction of the section of glass, in order to account for variations in thickness of the section of glass.

20. (canceled)

21. A glass etching system comprising:
a printing system for preparing a section of glass for etching, the printing system comprising a printer configured to print a mask directly on to the section of glass by depositing ink on to the section of glass; and
an etching bath for receiving the section of glass and for exposing at least a portion of the section of glass to an etching solution in order to remove colouring from the section of glass in areas not covered by the mask.

22. The glass etching system according to claim 21, the glass etching system comprising a washing station for washing the section of glass so as to remove the mask in order to provide a finished glass product.

23-24. (canceled)
